(19) United States
(12) Patent Application Publication
(10) Pub. No.: US 2016/0369751 A1
(43) Pub. Date: Dec. 22, 2016

(54) INTERNAL COMBUSTION ENGINE USING WATER AS AUXILIARY POWER

(71) Applicant: CHUN-TING CHEN, KAOHSIUNG CITY 804 (TW)

(72) Inventor: CHUN-TING CHEN, KAOHSIUNG CITY 804 (TW)

(21) Appl. No.: 14/745,558

(22) Filed: Jun. 22, 2015

(51) Int. Cl. F02M 25/03; F02B 61/00; F02M 25/022

(52) U.S. Cl. CPC F02M 25/03; F02M 25/0225; F02B 61/00

(57) ABSTRACT

An internal combustion engine using water as auxiliary power includes an engine body and a water spraying system. The engine body includes a combustion chamber. The water spraying system includes a water spraying motor having a water outlet and a nozzle connected to the water outlet of the water spraying motor. The nozzle includes an end received in the combustion chamber of the engine body.

### BACKGROUND OF THE INVENTION

The present invention relates to an engine and, more particularly, to an internal combustion engine using water as auxiliary power.

A turbojet engine is a type of turbine engines and is featured by using a high-pressure gas current produced from combustion of a fuel as the propulsive force, providing a mechanical power. The turbojet engine using a gas current as the propulsive force is generally used in high speed planes, such as fighter planes, civil aircrafts, etc.

A turbojet engine draws in the air or a gas through an inlet. The air or gas is firstly subject to multiple compression by turbine blades, and the compressed gas enters the combustion chamber to combine with a fuel (such as petroleum gas, hydrogen, gasoline, a fuel for jet planes, etc.) for subsequent combustion. The high temperature and high pressure gas resulting from the combustion expands to do work, driving the turbine to actuate a compressor. The hot exhaust gas passing through the turbine is ejected outward at high speed to produce a propulsive force.

However, the high heat generated during operation of the turbojet engine is not recycled for reuse as auxiliary power, which is a waste in energy. Furthermore, all internal engine systems have the same problem. Thus, improvement to the turbojet engine and all internal combustion engine systems for reusing the high heat is desired.

### BRIEF SUMMARY OF THE INVENTION

In view of the deficiency of the prior art, the present invention uses a liquid that turns into a steam after absorbing high heat, with the volume increasing rate being extremely high (the volume is increased by more than 1700 times if the temperature is above 600° C.). The steam pressure is sufficient to propel any object. Thus, the high heat generated by a turbojet engine or any internal combustion engine system can be recycled and reused to heat water into steam for generating extra kinetic energy, providing a larger propulsive force and more energy for the engine, serving as auxiliary power of the engine and thereby achieving the energy saving purposes.

An internal combustion engine using water as auxiliary power according to the present invention includes an engine body and a water spraying system. The engine body includes a combustion chamber. The water spraying system includes a water spraying motor having a water outlet and a nozzle connected to the water outlet of the water spraying motor. The nozzle includes an end received in the combustion chamber of the engine body.

The engine body can be a jet engine.

In an example, the engine body includes an exhaust pipe, and the combustion chamber includes a rear half portion adjacent to the exhaust pipe of the engine body. The nozzle is mounted to the rear half portion of the combustion chamber and is configured to output atomized water.

In another example, the engine body can be a reciprocating engine. The nozzle can be mounted to a top wall of the combustion chamber. The nozzle is configured to output atomized water into the combustion chamber.

The present invention is operated in a special environment (a high pressure and high temperature engine combustion chamber) into which a liquid fuel (water) is injected. When the turbojet engine operates, ambient low pressure gas is sucked in and compressed by a compressor to continuously compress the low pressure gas into high pressure gas which enters the combustion chamber. At this time, a fuel (such as petroleum gas, hydrogen, gasoline, a fuel for jet planes, etc.) is filled into the combustion chamber and undergoes the ignition/combustion stroke. The fuel explodes and generates high pressure and high temperature. Then, liquid water at the nozzle is atomized and injected into a distal end of the combustion chamber. The high temperature and high pressure resulting from the explosion of the fuel permits the atomized water to absorb a large quantity of the heat high and to immediately vaporize, and the volume is increased by more than 1700 times. The higher the temperature, the higher the volume increase rate. The momentous gasification (similar to explosion of the fuel) generates an expanding high pressure power. Thus, the liquid water can be used as a liquid fuel in a special environment to serve as auxiliary power. Thus, the power outputted by the engine, including the main power (such as petroleum gas, hydrogen, gasoline, a fuel for jet planes, etc.) and the auxiliary power (water), uses the same amount of fuel but provides a higher power output than conventional engines, reducing the waste in heat energy and providing great contribution in environmental protection.

The present invention will become clearer in light of the following detailed description of illustrative embodiments of this invention described in connection with the drawings.

### DESCRIPTION OF THE DRAWINGS

FIG. 1 is across sectional view of an internal combustion engine using water as auxiliary power according to the present invention.

FIG. 2 is a cross sectional view illustrating gas flow of the internal combustion engine using water as auxiliary power according to the present invention.

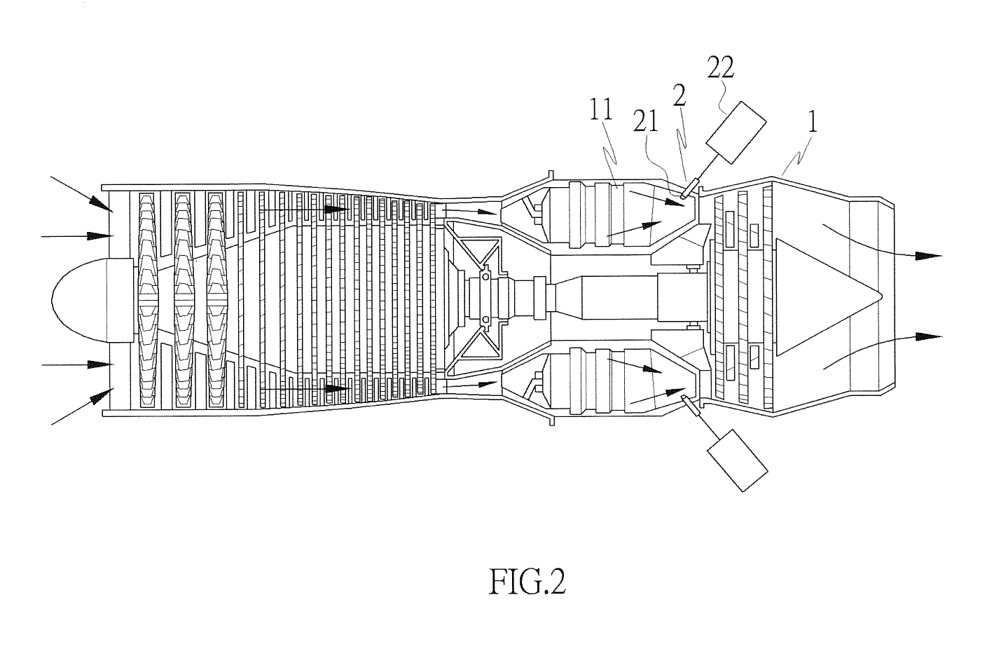

FIG. 3 is a diagrammatic view of another embodiment of the internal combustion engine using water as auxiliary power according to the present invention.

FIG. 4 is a diagrammatic view of a further embodiment of the internal combustion engine using water as auxiliary power according to the present invention.

### DETAILED DESCRIPTION OF THE INVENTION

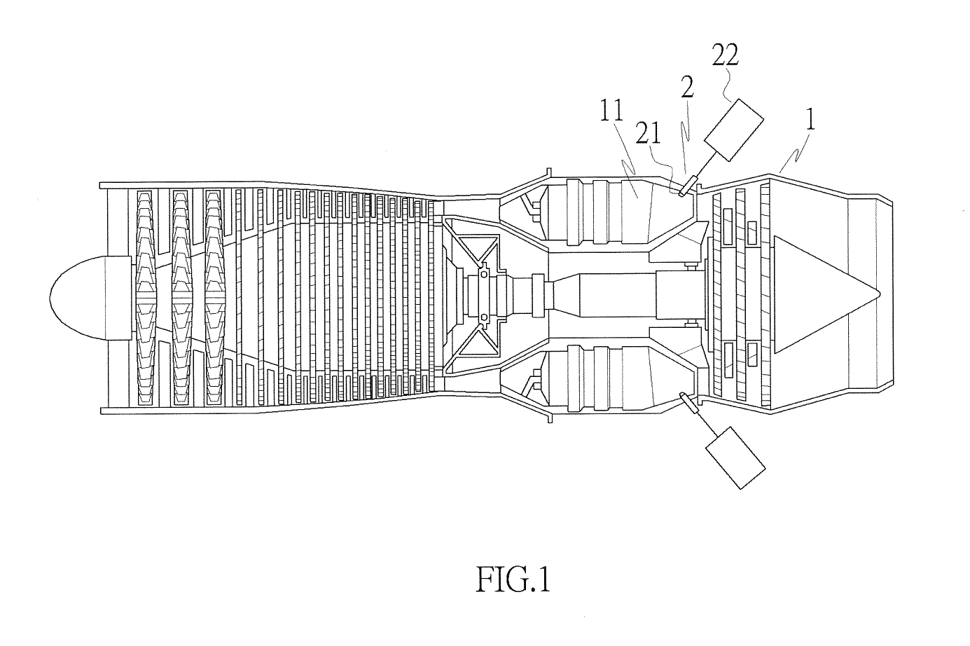

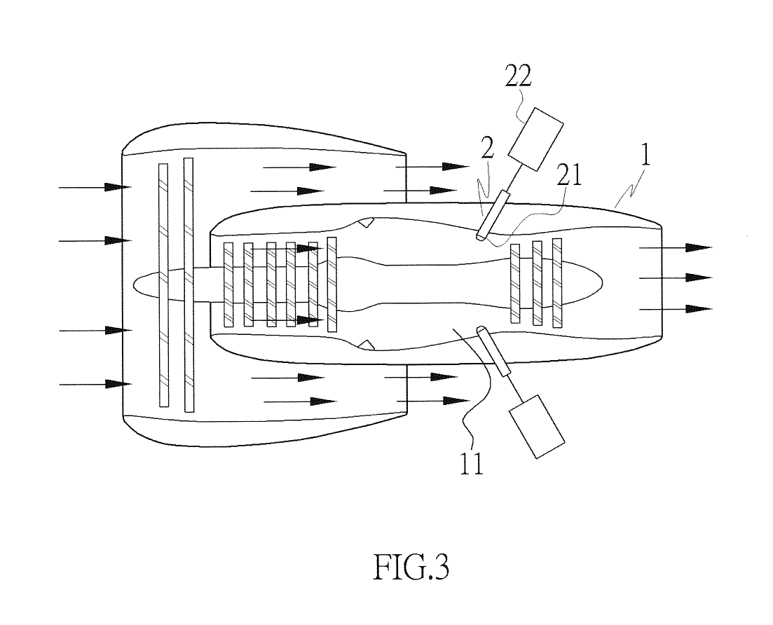

With reference to FIG. 1, an internal combustion engine using water as auxiliary power according to the present invention includes an engine body 1 and a water spraying system 2. The engine body 1 includes a combustion chamber 11. The engine body 1 is not limited to a turbojet engine or a reciprocating internal combustion engine. The engine body 1 can be of any mechanism using the gas generated during operation of an internal combustion system as the power. Furthermore, the internal combustion engine can be a turbojet engine shown in FIG. 1 or a turbojet engine shown in FIG. 3. The water spraying system 2 includes a water spraying motor 22 and a nozzle 21. An end of the nozzle 21 is connected to a water outlet of the water spraying motor 22. The other end of the nozzle 21 is received in the combustion chamber 11 of the engine body 1.

The features and advantages of the present invention will now be set forth by an example using a turbojet engine as the engine body 1.

The present invention is operated in a special environment (a high pressure and high temperature engine combustion chamber) into which a liquid fuel (water) is injected. When the turbojet engine operates, ambient low pressure gas is sucked in and compressed by a compressor to continuously compress the low pressure gas into high pressure gas which enters the combustion chamber 11. At this time, a fuel (such as petroleum gas, hydrogen, gasoline, a fuel for jet planes, etc.) is filled into the combustion chamber 11 and undergoes the ignition/combustion stroke. The fuel explodes and generates high pressure and high temperature. Then, liquid water at the nozzle 21 is atomized and injected into a distal end of the combustion chamber 11. The high temperature and high pressure resulting from the explosion of the fuel permits the atomized water to absorb a large quantity of the heat high and to immediately vaporize, and the volume is increased by more than 1700 times. The higher the temperature, the higher the volume increase rate. The momentous gasification (similar to explosion of the fuel) generates an expanding high pressure power. Thus, the liquid water can be used as a liquid fuel in a special environment to serve as auxiliary power. Thus, the power outputted by the engine, including the main power (gasoline) and the auxiliary power (water), uses the same amount of fuel but provides a higher power output than conventional engines, reducing the waste in heat energy and providing great contribution in environmental protection.

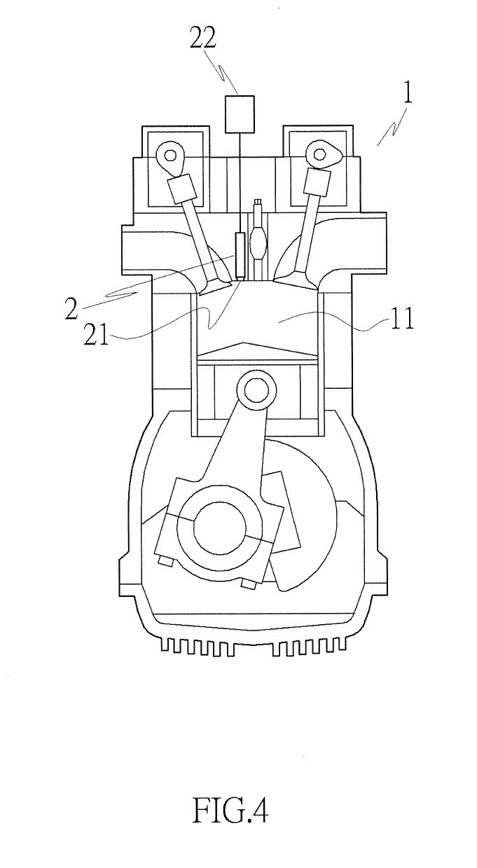

Preferably, the water spraying system 2 outputs atomized water into the combustion chamber 11. The nozzle 21 is preferably mounted to a rear half portion (namely, the portion adjacent to the exhaust pipe of the engine body 1) of the combustion chamber 11, such that the atomized water can more completely absorb the high heat generated during combustion of the fuel, obtaining a better expansion effect to produce more kinetic energy and a larger propulsive force. Furthermore, an impeller and a transmission mechanism can be mounted to an outer side of an outlet of the combustion chamber 11. The impeller is connected to the transmission mechanism. The exhaust gas from the combustion chamber 11 drives the transmission mechanism by the impeller 11, and the transmission mechanism drives another element, serving as auxiliary power. With reference to FIG. 4, the engine body 11 can be a reciprocating engine. In this embodiment, the nozzle 21 of the water spraying system 2 is mounted in the combustion chamber 11 and is preferably mounted to a top wall of the combustion chamber 11. Thus, when the combustion chamber 11 operates and proceeds to the explosion stroke, the temperature in the combustion chamber 11 reaches the highest point (namely, the optimal timing between the ignition/combustion stroke and the exhaust stroke). At this time, the nozzle 21 injects the atomized water into the combustion chamber 11. The other operational principles, features, and advantages have already been set forth hereinbefore, and redundant description is not required to avoid redundancy.

Although specific embodiments have been illustrated and described, numerous modifications and variations are still possible without departing from the scope of the invention. The scope of the invention is limited by the accompanying claims.

1. An internal combustion engine using water as auxiliary power, comprising an engine body and a water spraying system, with the engine body including a combustion chamber, with the water spraying system including a water spraying motor having a water outlet and a nozzle connected to the water outlet of the water spraying motor, and with the nozzle including an end received in the combustion chamber of the engine body.

2. The internal combustion engine using water as auxiliary power as claimed in claim 1, wherein the engine body is a jet engine.

3. The internal combustion engine using water as auxiliary power as claimed in claim 1, with the engine body including an exhaust pipe, with the combustion chamber including a rear half portion adjacent to the exhaust pipe of the engine body, with the nozzle mounted to the rear half portion of the combustion chamber, and with the nozzle configured to output atomized water.

4. The internal combustion engine using water as auxiliary power as claimed in claim 1, with the engine body being a reciprocating engine, with the nozzle mounted to a top wall of the combustion chamber, and with the nozzle configured to output atomized water into the combustion chamber.
